(19) United States
(12) Patent Application Publication
(10) Pub. No.: US 2012/0139409 A1
(43) Pub. Date: Jun. 7, 2012

(54) LIGHTING DEVICE AND VEHICLE HEADLAMP

(75) Inventors: Katsuhiko KISHIMOTO, Osaka-shi (JP); Kohsei Takahashi, Osaka-shi (JP)

(73) Assignee: SHARP KABUSHIKI KAISHA, Osaka-shi (JP)

(21) Appl. No.: 13/312,560

(22) Filed: Dec. 6, 2011

(30) Foreign Application Priority Data
Dec. 6, 2010 (JP) 2010-271752

(51) Int. Cl. H01J 1/63; F21S 8/10

(52) U.S. Cl. 313/483

(57) ABSTRACT

A headlamp 1 includes: a semiconductor laser 2, which emits laser light; and a light-emitting section 5, which includes at least either a fluorescent material sintered body obtained by sintering an oxynitride fluorescent material or a fluorescent material sintered body obtained by sintering an oxynitride fluorescent material and a nitride fluorescent material and which produces fluorescence upon receiving laser light emitted by the semiconductor laser 2. This allows the headlamp 1 to quickly radiate heat generated in the light-emitting section outward, thus bringing about an effect of preventing the light-emitting section from rising in temperature when irradiated with high-power and high-density laser light.

This Nonprovisional application claims priority under 35 U.S.C. §119(a) on Patent Application No. 2010-271752 filed in Japan on Dec. 6, 2010, the entire contents of which are hereby incorporated by reference.

### TECHNICAL FIELD

The present relates to a lighting device including a laser light source and a light-emitting section that produces fluorescence upon receiving laser light from the laser light source and, in particular, to a vehicle headlamp.

### BACKGROUND ART

In recent years, vigorous studies have been carried out on lighting devices that use, as illuminating light, fluorescence produced by using semiconductor light-emitting elements, such as light-emitting diodes (LEDs), laser diodes (LD), etc. as excitation light sources and irradiating light-emitting sections including fluorescent materials with excitation light generated from these excitation light sources.

Examples of such lighting devices are disclosed in Patent Literatures 1 and 2.

A light source (lighting device) of Patent Literature 1 has at least one LED for sending out a primary beam and at least one light-emitting converter for converting the primary beam into a secondary beam. Moreover, the light-emitting converter is a polycrystalline ceramic body, and the polycrystalline ceramic body per se acts wholly or partly as a light emitter. Further, the ceramic body is made of a base material at least part of which has been activated by a doping material.

Further, Patent Literature 2 describes a plate-like ceramic member that converts the wavelength of light emitted by a semiconductor light-emitting element. The plate-like ceramic member is composed of two or more types of ceramic material and divided into a plurality of blocks. Each of the blocks is made of one type of ceramic material selected from among the two or more types of ceramic material, and at least one type of ceramic material among the two types of ceramic material contains a wavelength-converting material that converts the wavelength of light.

### CITATION LIST

### Patent Literature 1

Japanese Patent Application Publication, Tokukai, No. 2004-146835 (Publication Date: May 20, 2004)

### Patent Literature 2

Japanese Patent Application Publication, Tokukai, No. 2009-177106 (Publication Date: Aug. 6, 2009)

### SUMMARY OF INVENTION

### Technical Problem

However, the conventional technologies have the following problems.

That is, as for the light source of Patent Literature, an LED is used as the light source. As such, Patent Literature 1 does not provide any solution for reducing a rise in temperature of the light-emitting section when the light-emitting section is irradiated with high-power and high-density laser light. Further, since the light-emitting converter of Patent Literature 1 is a ceramic body made of a base material selected from among aluminum oxide (Al₂O₃), a group of YAG, and/or Y₂O₃ (yttrium oxide), Patent Literature 1 does not use an oxynitride fluorescent material as a fluorescent material.

Furthermore, the ceramic member of Patent Literature 2 is a combination of a translucent material (Al₂O₃, etc.) and a fluorescent ceramic material that are separately divided. However, Patent Literature 2 neither discloses nor suggests that the fluorescent ceramic material has translucency. As such, the fluorescent ceramic material of Patent Literature 2 does not include a configuration in which it has translucency and serves as a fluorescent material and a radiator itself.

The present invention has been made in view of the foregoing problems, and it is an object to the present invention to provide a lighting device capable of preventing a light-emitting section from rising in temperature when irradiated with laser light and a vehicle headlamp including such a lighting device.

### Solution to Problem

In order to solve the foregoing problems, a lighting device according to the present invention includes: a laser light source, which emits laser light; and a light-emitting section, which includes at least either a fluorescent material sintered body obtained by sintering an oxynitride fluorescent material or a fluorescent material sintered body obtained by sintering an oxynitride fluorescent material and a nitride fluorescent material and which produces fluorescence upon receiving laser light emitted by the laser light source.

According to the foregoing configuration, the light-emitting section produces fluorescence upon receiving laser light emitted by the laser light source. Since such laser light is higher in power and density than light produced by using another type of excitation light source (e.g., an LED), the light-emitting section tends to rise in temperature when irradiated with such laser light. Therefore, unless heat generated in the light-emitting section is quickly radiated outward, the heat causes deterioration (discoloration, deformation) in the light-emitting section.

In this respect, the light-emitting section of the lighting device according to the present invention includes at least either a fluorescent material sintered body obtained by sintering an oxynitride fluorescent material or a fluorescent material sintered body obtained by sintering an oxynitride fluorescent material and a nitride fluorescent material, and a base material for the oxynitride fluorescent material is silicon nitride (SiN: thermal conductivity (approximately 20 W/mK), which is higher in thermal conductivity than many other fluorescent materials. That is, by including a light-emitting section that includes an oxynitride fluorescent material having high thermal conductivity, the lighting device according to the present invention allows heat generated in the light-emitting section to be quickly radiated outward, for example, by bringing a thermally conductive member into contact with the light-emitting section. Therefore, the lighting device according to the present invention can easily solve the problem of deterioration in the light-emitting section due to heat even if the light-emitting section is irradiated with high-power and high-density laser light.

In addition, the oxynitride fluorescent material increases in transparency when sintered to form a fluorescent material sintered body, thereby coming to exhibit high translucency. That is, by containing a fluorescent material sintered body obtained by sintering an oxynitride fluorescent material, the light-emitting section comes to serve as a fluorescent material and a radiator itself and, at the same time, have high translucency. Therefore, for example, when irradiated with blue laser light, the light-emitting section can convert part of the blue light into yellow light while transmitting the blue light and transmit part of the blue light because of its translucency. This allows the light-emitting section to output white light made by mixing the blue light and the yellow light together. Moreover, in so doing, the light-emitting section functions as a radiator itself, and as such, can also suppress heat deterioration.

Thus, by including the foregoing configuration, the lighting device according to the present invention brings about an effect of preventing the light-emitting section from rising in temperature when irradiated with laser light.

Further, in order to solve the foregoing problems, a lighting device according to the present invention includes: a laser light source, which emits laser light; and a light-emitting section, which includes an oxynitride fluorescent material and a sealant composed of silicon nitride and which produces fluorescence upon receiving laser light emitted by the laser light source.

According to the foregoing configuration, the light-emitting section includes an oxynitride fluorescent material and a sealant composed of silicon nitride. It should be noted here that a base material for the oxynitride fluorescent material is silicon nitride (SiN: thermal conductivity (approximately 20 W/mK), which is higher in thermal conductivity than many other fluorescent materials. Furthermore, the light-emitting section uses silicon nitride as the sealant for sealing in the oxynitride fluorescent material.

This causes the light-emitting section according to the present invention to include an oxynitride fluorescent material and a sealant both of which have high thermal conductivity; therefore, for example, by bringing a thermally conductive member into contact with the light-emitting section, heat generated in the light-emitting section can be quickly radiated outward. Therefore, the lighting device according to the present invention can easily solve the problem of deterioration in the light-emitting section due to heat even if the light-emitting section is irradiated with high-power and high-density laser light.

Further, the light-emitting section can transmit laser light as long as its thickness falls within a certain range. Therefore, as mentioned above, the light-emitting section can realize such a configuration as outputting white light made by mixing blue light and yellow light together. Moreover, in so doing, the light-emitting section functions as a radiator itself, and as such, can also suppress heat deterioration.

Thus, by including the foregoing configuration, the lighting device according to the present invention brings about an effect of preventing the light-emitting section from rising in temperature when irradiated with laser light.

### ADVANTAGEOUS EFFECTS OF INVENTION

As described above, a lighting device according to the present invention includes: a laser light source, which emits laser light; and a light-emitting section, which includes at least either a fluorescent material sintered body obtained by sintering an oxynitride fluorescent material or a fluorescent material sintered body obtained by sintering an oxynitride fluorescent material and a nitride fluorescent material and which produces fluorescence upon receiving laser light emitted by the laser light source.

Further, as described above, a lighting device according to the present invention includes: a laser light source, which emits laser light; and a light-emitting section, which includes an oxynitride fluorescent material and a sealant composed of silicon nitride and which produces fluorescence upon receiving laser light emitted by the laser light source.

Further, as described above, a vehicle headlamp according to the present invention includes: a lighting device as described above; and a reflecting mirror, which, by reflecting light emitted by the light-emitting section, forms a bundle of rays that travels through within a predetermined solid angle.

This makes it possible to provide a lighting device capable of preventing a light-emitting section from rising in temperature when irradiated with laser light and a vehicle headlamp including such a lighting device.

### BRIEF DESCRIPTION OF DRAWINGS

FIG. 1 is a diagram schematically showing a configuration of a headlamp according to the present embodiment.

FIG. 2 is a schematic view showing a light-emitting section of another embodiment.

FIG. 3 is a schematic view showing a light-emitting section of another embodiment.

FIG. 4 is a set of diagrams for explaining a method for fabricating a light-emitting section of FIG. 3.

FIG. 5 is a schematic view showing a light-emitting section of another embodiment.

FIG. 6 is a diagram for explaining a method for fabricating a light-emitting section of FIG. 5.

FIG. 7 is a schematic view showing a light-emitting section of another embodiment.

FIG. 8 is a schematic view showing a light-emitting section of another embodiment.

FIG. 9 shows (a) a diagram schematically showing a circuit diagram of a laser diode and (b) a perspective view showing a basic structure of a laser diode.

FIG. 10 is a cross-sectional view schematically showing a headlamp according to another embodiment of the present invention.

FIG. 11 is a diagram showing a positional relationship between ends of optical fibers of a headlamp according to another embodiment of the present invention and a light-emitting section of the headlamp.

### DESCRIPTION OF EMBODIMENTS

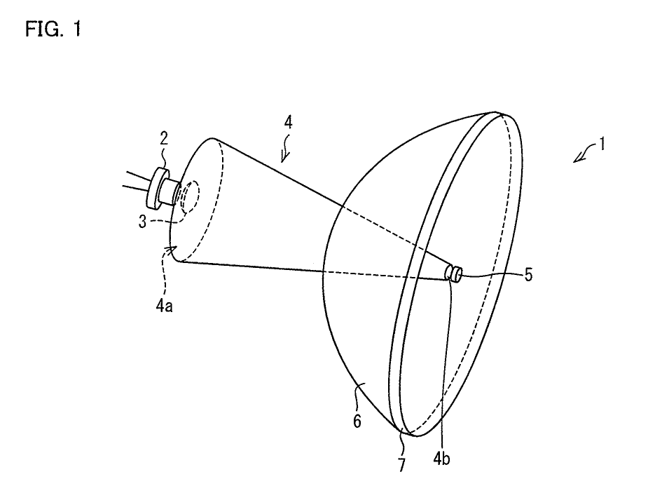

An embodiment of the present invention is described below with reference to FIG. 1, etc.

### Technical Idea of the Present Invention

Since laser light produced by using a laser light source as an excitation light source is higher in power and density than light produced by using another type of excitation light source (e.g., an LED), a light-emitting section tends to rise in temperature when irradiated with such laser light. For this reason, heat generated in the light-emitting section must be quickly radiated outward; otherwise, the heat causes deterioration (discoloration, deformation) in the light-emitting section. However, the function of heat radiation cannot be emphasized to such an extent that the light-emitting section becomes lower in luminous efficiency.

In view of these circumstances, the inventors of the present invention conceived that by using a light-emitting section which includes a fluorescent material sintered body obtained by sintering an oxynitride fluorescent material and which produces fluorescence upon receiving laser light emitted by a laser light source, a lighting device can be realized which, without decreasing luminous efficiency, can prevent the light-emitting section from rising in temperature when irradiated with laser light.

A lighting device of the present invention has been made on the basis of such a technical idea. The lighting device of the present invention is described here by taking, as an example, a headlamp (lighting device, vehicle headlamp) 1 that satisfies standards of light distribution characteristics of an automotive headlamp designed to provide a driving beam. However, the lighting device of the present invention may be realized in the form of a headlamp for vehicles and mobile objects (e.g., human beings, ships, aircrafts, submarines, rockets, etc.) other than automobiles or may be realized in the form of other lighting devices such as search lights. Further, the lighting device of the present invention can also be applied to a headlamp for an automobile to go by an automobile coming from the opposite direction (passing beam).

### Configuration of a Headlamp 1

First, a configuration of a headlamp (lighting device) 1 according to the present embodiment is described with reference to FIG. 1. FIG. 1 is a diagram schematically showing a configuration of a headlamp 1. As shown in FIG. 1, the headlamp 1 includes a laser diode 2 (laser light source), an aspheric lens 3, a light guiding section 4, a light-emitting section 5, and a reflecting mirror 6.

### Laser Diode 2

The laser diode 2 functions as an excitation light source that emits excitation light. The laser diode 2 may comprise a single laser diode 2 or a plurality of laser diodes 2. Further, it is possible to use, as the laser diode 2, a laser diode having a single luminous point on a single chip or a laser diode having a plurality of luminous points on a single chip. The laser diode 2 used in the present embodiment has a single luminous point on a single chip.

The laser diode 2 for example has a single luminous point (single stripe) on a single chip, emits laser light at a wavelength 405 nm (blue-violet), has a light output of 1.0 W, an operating voltage of 5 V, a current of 0.7 A, and is sealed in a package (stem) 5.6 mm in diameter. Further, the laser diode 2 used in the present embodiment comprises ten laser diodes 2, yielding a light output of 10 W in total. For convenience, FIG. 1 illustrates only one laser diode 2. The wavelength of light that is emitted by the laser diode 2 is not limited to 405 nm.

### Aspheric Lens 3

The aspheric lens 3 is a lens for causing laser light emitted by each laser diode 2 to strike a light entrance surface 4a at one end of the light guiding section 4. For example, it is possible to use, as the aspheric lens 3, an FLKN1 405 manufactured by Alps Electric Co., Ltd. The aspheric lens 3 is not particularly limited in shape or material, as long as it is a lens having the aforementioned function; however, it is preferable that the aspheric lens 3 be made of a material which has a high light transmission near the emission wavelength (405 nm) the laser diode 2 and which has great heat resistance.

The aspheric lens 3 converges laser light emitted by the laser diode 2 and guides the laser light toward a comparatively small light entrance surface (e.g., 1 mm or smaller in diameter). Therefore, in a case where the light entrance surface 4a of the light-emitting section 5 is large to such an extent that there is no need to converge laser light, there is no need to provide such an aspheric lens 3.

### Light Guiding Section 4

The light guiding section 4 is a truncated conical light guiding member that focuses laser light emitted by the laser diode 2 and guides the laser light toward the light-emitting section (laser light irradiation surface of the light-emitting section 5), and is optically coupled via the aspheric lens 3 (or directly) to the laser diode 2. The light guiding section 4 has a light entrance surface 4a (entrance end) that receives laser light emitted by the laser diode 2 and a light exit surface 4b (exit end) through which the laser light received by the light entrance surface 4a exits toward the light-emitting section 5.

The light exit surface 4b is smaller in area than the light entrance surface 4a. Therefore, each beam of laser light having entered through the light entrance surface 4a travels forward while being reflected by a side surface of the light guiding section 4, thereby being converged to exit through the light exit surface 4b.

The light guiding section 4 is constituted by BK7 (borosilicate crown glass), quartz glass, acrylic resin, and other transparent materials. Further, the light entrance surface 4a and the light exit surface 4b may each have a planer shape or a curve surface shape.

The light guiding section 4 may have a truncated pyramidal shape and be an optical fiber, as long as it guides laser light from the laser diode 2 toward the light-emitting section 5. Alternatively, it is possible to directly irradiate the light-emitting section 5 with laser light from the laser diode 2 through the aspheric lens 3, instead of providing such a light guiding section 4. Such a configuration is possible in a case where the distance between the laser diode 2 and the light-emitting section 5 is short.

### Composition of the Light-Emitting Section 5

The light-emitting section 5 produces white fluorescence upon receiving laser light having exited from the light guiding section 4 through the light exit surface 4b, and includes a fluorescent material sintered body obtained by sintering an oxynitride fluorescent material. There is a typical oxynitride fluorescent material commonly called a SiAlON (silicon aluminum oxynitride) fluorescent material. The SiAlON fluorescent material is a substance composed of silicon nitride some of whose silicon atoms have been substituted by aluminum atoms and some of whose nitrogen atoms have been substituted by oxygen atoms. Such a SiAlON fluorescent material can be made by aluminum oxide (Al₂O₃), silica (SiO₂), and a rare-earth element, etc. in a solid state in silicon nitride (Si₃N₄). Examples of SiAlON fluorescent materials that emit blue light upon receiving excitation light include a Ce³⁺-activated Caα-SiAlON fluorescent material, a Ce³⁺-activated β-SiAlON fluorescent material, etc.

Other typical examples of oxynitride fluorescent materials include a JEM-phase-containing oxynitride fluorescent material (JEM-phase fluorescent material). A JEM-phase fluorescent material is a substance found to be generated in the process of adjusting a SiAlON fluorescent material stabilized by a rare-earth element. Further, a JEM phase is ceramic discovered as a grain boundary phase of a silicon nitride material and, in general, is a crystal phase (oxynitride crystal) having a particular atomic arrangement composed of a composition represented by a composition formula M¹Al(Si_{6-z}Al_{z})N_{10-z}O_{z} (where M¹ is at least one type of element selected from the group consisting of La, Ce, Pr, Nd, Sm, Eu, Gd, Tb, Dy, Ho, Er, Tm, Yb, and Lu), whose parameter is z. A JEM phase is high in crystal covalency and therefore has great heat resistance.

An example of a JEM-phase fluorescent material that emits blue light upon receiving excitation light is a Ce³⁺-activated (-doped) JEM-phase fluorescent material (JEM phase: Ce fluorescent material). By containing a Ce component, the JEM-phase fluorescent material becomes more likely to absorb excitation light at wavelengths of around 350 nm to 420 nm and emit blue to blue-green light, exhibits a broad range of emission half-widths, and therefore can sufficiently cover, for example, a wavelength band that is high in spectral luminous efficiency under scotopic vision. Further, the JEM phase: Ce fluorescent material has a peak wavelength of 480 nm at an excitation wavelength of 360 nm and has a luminous efficiency of 60% then. Further, the JEM phase: Ce fluorescent material has a peak wavelength of 490 nm at an excitation wavelength of 405 nm and has a luminous efficiency of 50% then.

Further, examples of nitride fluorescent materials that emit red light include Eu²⁺-doped CaAlSiN₃: fluorescent material (CASN: Eu fluorescent material), Eu²⁺-doped SrCaAlSiN₃: fluorescent material (SCASN: Eu fluorescent material), etc.

The CASN: Eu fluorescent material produces red fluorescence at excitation wavelengths of 350 nm to 450 nm, and has a peak wavelength of 650 nm and a luminous efficiency of 73%. Further, the SCASN: Eu fluorescent material produces red fluorescence at excitation wavelengths of 350 nm to 450 nm, and has a peak wavelength of 630 nm and a luminous efficiency of 70%.

Use of these red fluorescent materials allows realization of white light with very good color rendering. Further, a red fluorescent material can enhance the visibility of a red object irradiated with white light emitted therefrom. Since road signs use red, yellow, and blue as their background colors, use of a red fluorescent material in the light-emitting section 5 of the headlamp 1 is effective in recognizing a road sign whose background color is red.

Furthermore, examples of oxynitride fluorescent materials that emit green light include Eu²⁺-doped β-SiAlON fluorescent material, etc. The Eu²⁺-doped β-SiAlON fluorescent material exhibits strong emission of a luminescence peak wavelength of approximately 540 nm upon receiving ultraviolet to blue excitation light. This fluorescent material has an emission spectral full width at half maximum of approximately 55 nm.

The following describes further features of the light-emitting section 5 according to the present embodiment.

In general, a sealant is used in a light-emitting section. It is preferable that the sealant be low-melting inorganic glass; however, the sealant may be resin such as silicon resin or organic/inorganic hybrid glass, unless extremely high-power and high-density excitation light is used. However, the light-emitting section may be one obtained by packing a fluorescent material down, but in such case, deterioration in the light-emitting section 5 due to irradiation with laser light may be accelerated.

In this respect, the light-emitting section 5 includes at least either a fluorescent material sintered body obtained by sintering an oxynitride fluorescent material or a fluorescent material sintered body obtained by sintering an oxynitride fluorescent material and a nitride fluorescent material. Silicon nitride (SiN), which is a base material for the oxynitride fluorescent material, has a high thermal conductivity of approximately 20 W/mK and has thermal resistance one-twentieth as great as that of normal inorganic glass having a fluorescent material dispersed thereinto. Therefore, use of the oxynitride fluorescent material in the light-emitting section 5 is expected to bring about a great heat radiation effect.

Furthermore, a process of sintering the oxynitride fluorescent material and the nitride fluorescent material gives a transparent sintered body having translucency. This allows the light-emitting section 5 to have translucency and function as a fluorescent material and a radiator itself. Therefore, the light-emitting section 5 can keep high conversion efficiency with respect to high-power and high-density laser light, and, for example, by bringing a thermally conductive member into contact with the light-emitting section 5, heat generated in the light-emitting section 5 can be quickly radiated outward. Further, deterioration (discoloration, deformation) in the light-emitting section 5 due to heat can be suppressed, so that the life of the headlamp 1 can be extended.

### EMBODIMENTS

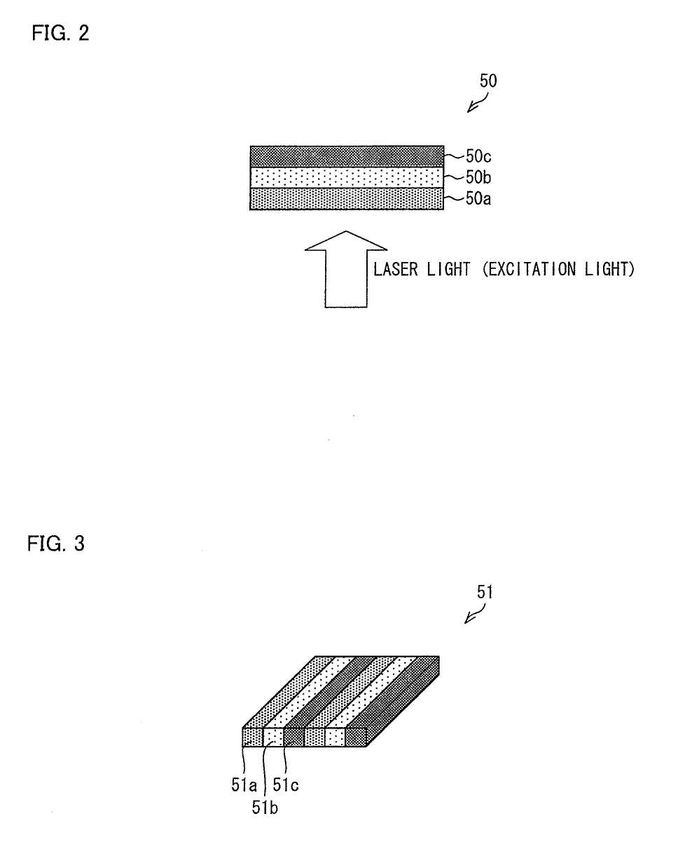

Some embodiments of light-emitting sections 5 are described below with reference to FIG. 2, etc. It should be noted that the already described content is not described below. Further, the materials, shapes, and various numerical values described herein are merely examples and are not supposed to limit the present invention.

### Embodiment 1

Still another embodiment is described with reference to FIG. 2. FIG. 2 is a schematic view showing a light-emitting section 50 of another embodiment.

The light-emitting section 50 includes plural types of fluorescent material sintered body that produce different colors of fluorescence from each other, with the plural types of fluorescent material sintered body joined on top of each other along an optical axis of laser light. More specifically, the light-emitting section 50 includes: a fluorescent material sintered body (sintered body) 50a, which produces red fluorescence when irradiated with laser light; a fluorescent material sintered body (sintered body) 50b, which produces green fluorescence when irradiated with laser light; and a fluorescent material sintered body (sintered body) 50c, which produces blue fluorescence when irradiated with laser light. The fluorescent material sintered bodies 50a to 50c are joined on top of each other in the order named along the direction from which laser light comes.

These layers are fabricated separately from each other, then treated with heat while joined on top of each other, and thus fused together. While fused, the layers are heated to 1000° C. or higher in a nitrogen atmosphere. It is preferable that the nitrogen atmosphere be at higher than atmospheric pressure. It is preferable that the thickness of each layer before fusion be in the range of 100 μm or greater to 500 μm or less, and that the effective density of a fluorescent material (silicon nitride doped with a rare earth metal serving as a luminescent center) be approximately 1% to 15% of the total.

In view of luminous efficiency and the like, a preferred example of a nitride fluorescent material that emits red light when irradiated with laser light is a Eu-doped CASN fluorescent material, which may contain Sr (strontium). Similarly, a preferred example of an oxynitride fluorescent material that emits green light when irradiated with laser light is a Eu-doped β-SiAlON fluorescent material. Further, preferred examples of an oxynitride fluorescent material that emits blue light when irradiated with laser light are a Ce-doped Caα-SiAlON fluorescent material, a Ce-doped β-SiAlON fluorescent material, and a Ce-doped JEM-phase fluorescent material.

It should be noted that the order in which the plural types of sintered body that produce different colors of fluorescence from each other are joined on top of each other along an optical axis of the laser light to form the light-emitting section 50 is not limited to the order described above. Further, the plural types of sintered body are not limited to the three types of fluorescent material sintered body that produce blue, red, and green fluorescence, respectively, and may be fluorescent material sintered bodies that produce other colors of fluorescence.

### Embodiment 2

Still another embodiment is described with reference to FIG. 3. FIG. 3 is a schematic view showing a light-emitting section 51 of another embodiment.

The light-emitting section 51 includes plural types of fluorescent material sintered body that produce different colors of fluorescence from each other, with the plural types of fluorescent material sintered body arranged adjacent to each other. More specifically, the light-emitting section 51 includes: a fluorescent material sintered body 51a, which produces red fluorescence when irradiated with laser light; a fluorescent material sintered body 51b, which produces green fluorescence when irradiated with laser light; and a fluorescent material sintered body 51c, which produces blue fluorescence when irradiated with laser light. The fluorescent material sintered bodies 51a to 51c are each in the shape of a stripe and are arranged adjacent to each other. In FIG. 3, the light-emitting section 51 is constituted by a fluorescent material sintered body 51a adjoining a fluorescent material sintered body 51b adjoining a fluorescent material sintered body 51c adjoining a fluorescent material sintered body 51a and so on.

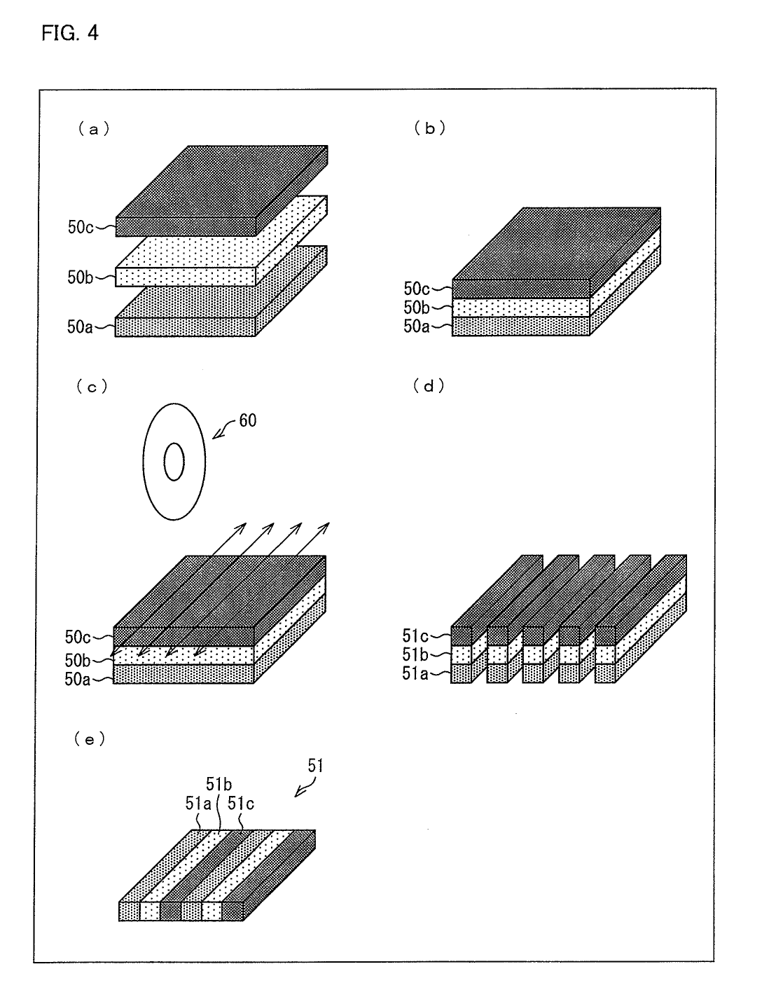

In the following, a method for fabricating a light-emitting section 51 of FIG. 3 is described with reference to FIG. 4. FIG. 4 is a set of diagrams for explaining a method for fabricating a light-emitting section 51 of FIG. 3.

(a) of FIG. 4 shows how a fluorescent material sintered body 50a that produces red fluorescence when irradiated with laser light, a fluorescent material sintered body 50b that produces green fluorescence when irradiated with laser light, and a fluorescent material sintered body 50c that produces blue fluorescence when irradiated with laser light are joined on top of each other. It should be noted that these layers are fabricated separately from each other.

(b) of FIG. 4 shows how the layers joined on top of each other are treated with heat and thus fused together. It is preferable that the fusion be carried out under the conditions described with reference to FIG. 2. Further, in (b) of FIG. 4, the layers do not need to be fused together but may be simply joined to each other.

(c) of FIG. 4 shows how the fluorescent material sintered bodies 50a to 50c fused together cut by a cutter 60 or the like provided with a rotary blade. The fluorescent material sintered bodies 50a to 50c fused together may be cut along any direction, but it is preferable that the fluorescent material sintered bodies 50a to 50c fused together be cut at regular intervals perpendicularly to a surface of the fluorescent material sintered body 50c. This makes it possible to fabricate a well-formed light-emitting section 51 in a later step.

(d) of FIG. 4 shows how the fluorescent material sintered bodies 50a to 50c fused together look after they have been cut at regular intervals perpendicularly to the surface of the fluorescent material sintered body 50c. (d) of FIG. 4 illustrates a total of five blocks each including fluorescent material sintered bodies 51a to 51c joined on top of each other in the order named.

(e) of FIG. 4 the fluorescent material sintered bodies 51a to 51c fused together are laid flat (to a horizontal position in the drawing), and the fluorescent material sintered body 51c of the first block and the fluorescent material sintered body 51a of the second block are fused together.

Thus formed is a light-emitting section 51 of FIG. 3.

### Embodiment 3

Next, a modification of a light-emitting section 51 is described. FIG. 3 has illustrated that a light-emitting section 51 is constituted by a fluorescent material sintered body 51a adjoining a fluorescent material sintered body 51b adjoining a fluorescent material sintered body 51c adjoining a fluorescent material sintered body 51a.

On the other hand, a modification of a light-emitting section 51 according to the present embodiment is provided with a translucent medium which replaces any one of the fluorescent material sintered bodies 51a to 51c, which is identical in position and similar in shape to the fluorescent material sintered body it replaces, and which transmits laser light. For example, a modification of a light-emitting section 51 according to the present embodiment as would be shown in FIG. 3 is constituted by a fluorescent material sintered body 51a adjoining a fluorescent material sintered body 51b adjoining a translucent medium adjoining a fluorescent material sintered body 51a and so on.

Alternatively, a modification of a light-emitting section 51 according to the present embodiment is provided with a translucent medium which is added to the fluorescent material sintered bodies 51a to 51c, which is similar in shape to the fluorescent material sintered bodies, and which transmits laser light. For example, a modification of a light-emitting section 51 according to the present embodiment as would be shown in FIG. 3 is constituted by a fluorescent material sintered body 51a adjoining a fluorescent material sintered body 51b adjoining a fluorescent material sintered body 51c adjoining a translucent medium adjoining a fluorescent material sintered body 51a.

Such a modification is described by taking, as an example, a case where a light-emitting section 51 is composed of a fluorescent material sintered body 51a that produces red fluorescent, a fluorescent material sintered body 51b that produces green fluorescent, and a translucent medium and the light-emitting section 51 is irradiated with blue laser light.

In such a case, the light-emitting section 51 can output white light made by mixing together red light outputted from the fluorescent material sintered body 51a, green light outputted from the fluorescent material sintered body 51b, and blue laser light having traveled through the translucent medium.

That is, the light-emitting section 51 allows laser light traveling through the translucent medium to be outputted from the light-emitting section 51 with no change in color of the laser light, thus eliminating the need for the light-emitting section 51 to have a fluorescent material sintered body 51 for outputting blue light, which is the color of the laser light.

Since a coherent component contained in laser light is highly likely to cause damage to human eyes, there may a case where it is considered problematic to directly output the laser light from the lighting device outward. In such a case, it is possible to use, for example, a transmitting filter to output only incoherent light toward the outside of the lighting device.

Further, the translucent medium needs only be made of a translucent material such as glass or Al₂O₃. Furthermore, the translucent medium may be realized in the form of a configuration which includes a scattering material that scatters laser light passing through the inside and which thereby scatters, in many directions, laser light passing through the translucent medium. The translucent medium thus configured to include a scattering material makes it possible to output only incoherent light toward the outside of the lighting device.

### Embodiment 4

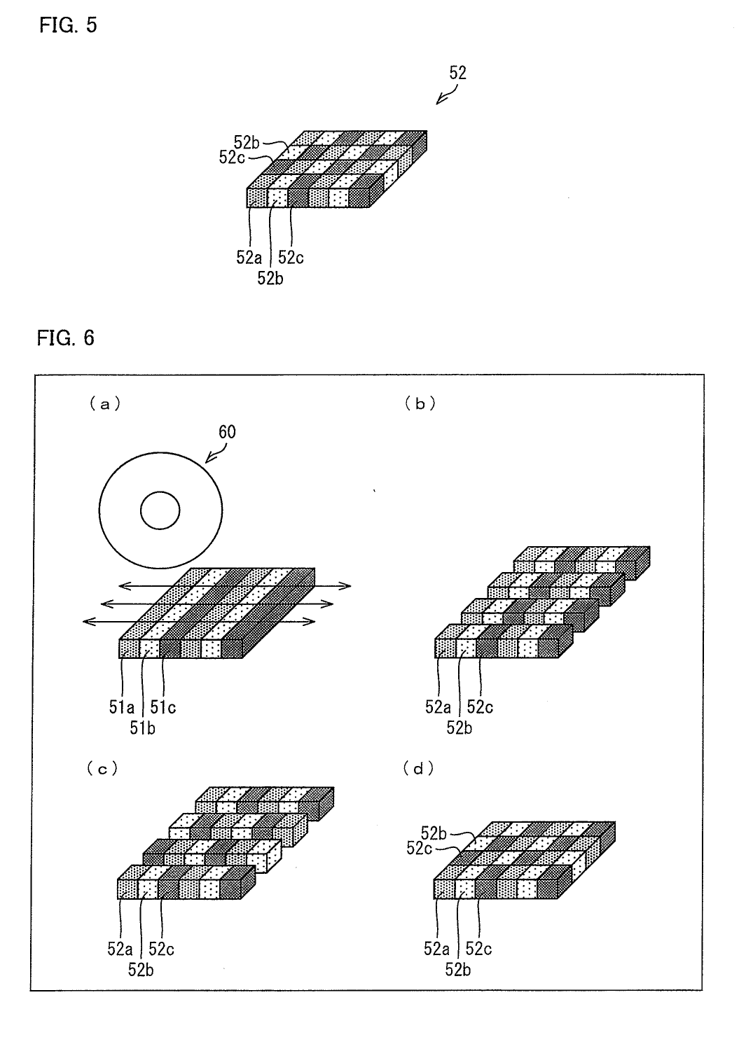

Still another embodiment is described with reference to FIG. 5. FIG. 5 is a schematic view showing a light-emitting section 52 of another embodiment.

The light-emitting section 52 includes plural types of fluorescent material sintered body that produce different colors of fluorescence from each other, with the plural types of fluorescent material sintered body arranged adjacent to each other. More specifically, the light-emitting section 52 includes: a fluorescent material sintered body 52a, which produces red fluorescence when irradiated with laser light; a fluorescent material sintered body 52b, which produces green fluorescence when irradiated with laser light; and a fluorescent material sintered body 52c, which produces blue fluorescence when irradiated with laser light. The fluorescent material sintered bodies 52a to 52c are each substantially in the shape of a cube and are arranged adjacent to each other in a matrix manner with a certain degree of regularity. In FIG. 5, on the assumption that the fluorescent material sintered body 52a located at the lower left in the drawing is a basing point, the fluorescent material sintered bodies 52a to 52c are repeatedly arranged in the order named along a transverse direction. Further, the fluorescent material sintered bodies 52a, 52c, and 52b are repeatedly arranged in the order named along a longitudinal direction.

In the following, a method for fabricating a light-emitting section 52 of FIG. 5 is described with reference to FIG. 6. FIG. 6 is a set of diagrams for explaining a method for fabricating a light-emitting section 52 of FIG. 5.

With the state of (e) of FIG. 4 as a starting point, (a) of FIG. 6 shows how the striped fluorescent material sintered bodies 51a to 51c are cut by a cutter 60 along a direction perpendicular to their longer sides. The fluorescent material sintered bodies 51a to 51c may be cut along any direction, but it is preferable that the fluorescent material sintered bodies 51a to 51c be cut at regular intervals along a direction perpendicular to the longer sides of the fluorescent material sintered body 51a, etc. This makes it possible to fabricate a well-formed light-emitting section 52 in a later step.

(b) of FIG. 6 shows how the striped fluorescent material sintered bodies 51a to 51c look after they have been cut by the cutter 60 along the direction perpendicular to their longer sides. (b) of FIG. 6 illustrates two blocks each including substantially cubic fluorescent material sintered bodies 52a to 52c fused together in the order named, with the two blocks fused together along a transverse direction in the drawing.

(c) of FIG. 6 shows a group of rows of fluorescent material sintered bodies 52a to 52c arranged along a transverse direction, with each row displaced in a transverse direction from the state of (b) of FIG. 6. On the assumption that the fluorescent material sintered body 52a located at the lower left in the drawing is a basing point, the fluorescent material sintered bodies 52a to 52c are repeatedly arranged in the order named along a transverse direction. Further, the fluorescent material sintered bodies 52a, 52c, and 52b are repeatedly arranged in the order named along a longitudinal direction.

(d) of FIG. 6 shows how the fluorescent material sintered bodies adjacent to each other in the state of (c) of FIG. 6 are fused together.

Thus formed is a light-emitting section 52 of FIG. 5.

### Embodiment 5

Next, a modification of a light-emitting section 52 is described. FIG. 5 has illustrated that a fluorescent material sintered body 52a that produces red fluorescence, a fluorescent material sintered body 52b that produces green fluorescence, and a fluorescent material sintered body 52c that produces blue fluorescence are each substantially in the shape of a cube and are arranged adjacent to each other in a matrix manner with a certain degree of regularity, whereby a light-emitting section 52 is formed.

On the other hand, a modification of a light-emitting section 52 according to the present embodiment is provided with a translucent medium which replaces any one of the fluorescent material sintered bodies 52a to 52c, which is identical in position and similar in shape to the fluorescent material sintered body it replaces, and which transmits laser light. For example, in a modification of a light-emitting section 52 according to the present embodiment as would be shown in FIG. 5, on the assumption that the fluorescent material sintered body 52a located at the lower left in the drawing is a basing point, the fluorescent material sintered body 52a, the fluorescent material sintered body 52b, and the translucent medium are repeatedly arranged in the order named along a transverse direction. Further, the fluorescent material sintered bodies 52a, the translucent medium, and the fluorescent material sintered body 52b are repeatedly arranged in the order named along a longitudinal direction.

Alternatively, a modification of a light-emitting section 52 according to the present embodiment is provided with a translucent medium which is added to the fluorescent material sintered bodies 52a to 52c, which is similar in shape to the fluorescent material sintered bodies, and which transmits laser light. For example, in a modification of a light-emitting section 52 according to the present embodiment as would be shown in FIG. 5, on the assumption that the fluorescent material sintered body 52a located at the lower left in the drawing is a basing point, the fluorescent material sintered bodies 52a to 52c and the translucent medium are repeatedly arranged in the order named along a transverse direction. Further, the fluorescent material sintered bodies 52a, the fluorescent material sintered bodies 52c, the translucent medium, and the fluorescent material sintered bodies 52b are repeatedly arranged in the order named along a longitudinal direction.

A possible example of such a modification is a case where a light-emitting section 52 is composed of a fluorescent material sintered body 52a that produces red fluorescent, a fluorescent material sintered body 52b that produces green fluorescent, and a translucent medium and the light-emitting section 52 is irradiated with blue laser light. It should be noted that the effects, etc. of such a modification are the modification of the light-emitting section 51 described with reference to FIG. 3, and as such, are not described in detail here.

### Embodiment 6

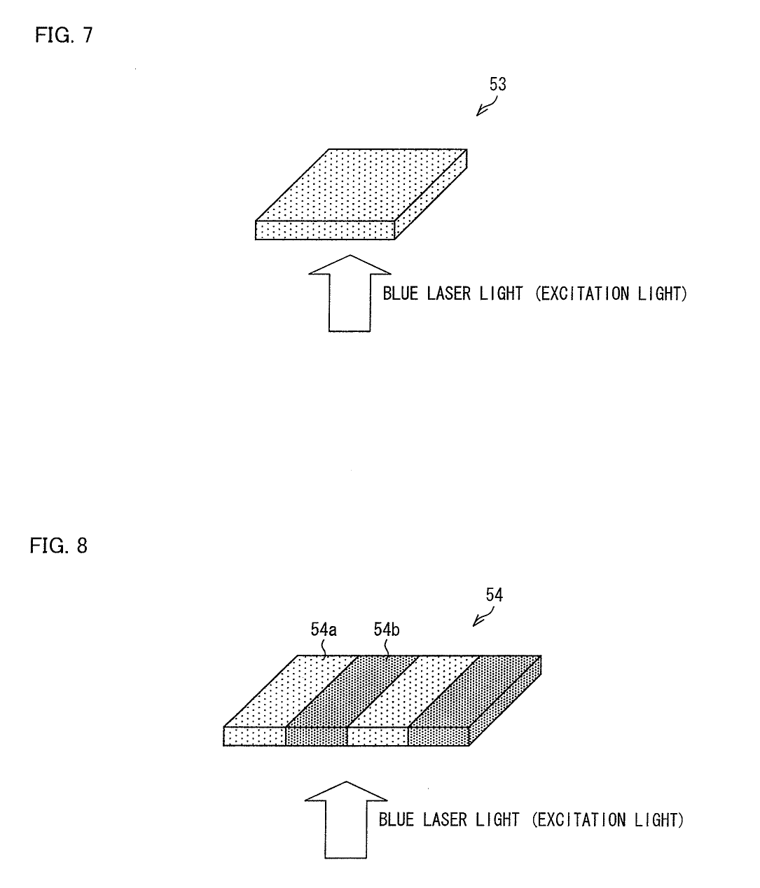

Still another embodiment is described with reference to FIG. 7. FIG. 7 is a schematic view showing a light-emitting section 53 of another embodiment.

The light-emitting section 53 is composed solely of a single layer of oxynitride fluorescent material that emits yellow fluorescence when irradiated with blue laser light, with the layer sintered to form a translucent fluorescent material sintered body. When irradiated with blue laser light, the light-emitting section 53 converts part of the blue light into yellow light while transmitting the blue light and transmits part of the blue light as it is. Then, the light-emitting section 53 outputs light that is emitted as white light made by mixing the blue light and the yellow light together.

Thus, the present embodiment also encompasses a light-emitting section composed solely of a single layer of oxynitride fluorescent material sintered to include a translucent fluorescent sintered body.

### Embodiment 7

Next, a light-emitting section 54, which is a modification of a light-emitting section 53, is described with reference to FIG. 8. FIG. 8 is a schematic view showing a light-emitting section 54 of another embodiment.

As shown in FIG. 8, the light-emitting section 54 includes an oxynitride fluorescent material 54a that emits yellow fluorescence when irradiated with blue lease light and a translucent medium 54b that transmits laser light, with the oxynitride fluorescent material 54a and the translucent medium 54b repeatedly arranged adjacent to each other.

This allows the light-emitting section 54 to output white light made by mixing together yellow light outputted from the fluorescent material sintered body 54a and blue laser light having traveled through the translucent medium. Moreover, by appropriately changing the materials, sizes, etc. of the fluorescent material sintered body 54a and of the translucent medium 54b, the light-emitting section 54 is allowed to easily realize controlling of color temperatures, such as emitting of high color temperature white light.

### Embodiment 8

Next, a light-emitting section according to sill another embodiment is described. A light-emitting section according to the present embodiment includes an oxynitride fluorescent material and a sealant composed of silicon nitride. It should be noted here that a base material for the oxynitride fluorescent material is silicon nitride (SiN: thermal conductivity (approximately 20 W/mK), which is higher in thermal conductivity than many other fluorescent materials. Furthermore, the light-emitting section uses silicon nitride as the sealant for sealing in the oxynitride fluorescent material. That is, by including a light-emitting section that includes an oxynitride fluorescent material having high thermal conductivity, the lighting device according to the present invention allows heat generated in the light-emitting section to be quickly radiated outward, for example, by bringing a thermally conductive member into contact with the light-emitting section. Therefore, the lighting device according to the present invention can easily solve the problem of deterioration in the light-emitting section due to heat even if the light-emitting section is irradiated with high-power and high-density laser light.

This causes the light-emitting section according to the present embodiment to include an oxynitride fluorescent material and a sealant both of which have high thermal conductivity; therefore, for example, by bringing a thermally conductive member into contact with the light-emitting section, heat generated in the light-emitting section can be quickly radiated outward. Therefore, the lighting device according to the present embodiment can easily solve the problem of deterioration in the light-emitting section due to heat even if the light-emitting section is irradiated with high-power and high-density laser light.

Further, the light-emitting section can transmit laser light as long as its thickness falls within a certain range. Therefore, as mentioned above, the light-emitting section can realize such a configuration as outputting white light made by mixing blue light and yellow light together. Moreover, in so doing, the light-emitting section functions as a radiator itself, and as such, can also suppress heat deterioration.

### Placement and Shape of the Light-Emitting Section 5

The light-emitting section 5 is fixed at the focal position of the reflecting mirror 6 or at a position nearby in such a way as to face the light exit surface 4b. This is not meant to limit how the position of the light-emitting section 5 is fixed. The position of the light-emitting section 5 may be fixed by a rod-like or cylindrical member extending from the reflecting mirror 6.

The shape of the light-emitting section 5 is not particularly limited and may be cuboidal or cylindrical. In the present embodiment, for example, the light-emitting section 5 is in the shape of a cylinder 2 mm in diameter and 0.8 mm in thickness (height). Further, that laser light irradiation surface of the light-emitting section 5 which is irradiated with laser light does not necessarily need to be a flat surface and may be a curved surface. However, for the purpose of controlling reflection of laser light, it is preferable that the laser light irradiation surface be a flat surface perpendicular to an optical axis of laser light.

Further, the light-emitting section 5 does not need to be 0.8 mm in thickness. Further, the required thickness of the light-emitting section 5 here varies according to the proportions of the sealant and the fluorescent material in the light-emitting section 5. An increase in content of the fluorescent material in the light-emitting section 5 leads to an increase in efficiency with which laser light is converted into white light, thus allowing a reduction in thickness of the light-emitting section 5.

### Reflecting Mirror 6

The reflecting mirror 6 has an opening and reflects incoherent light emitted by the light-emitting section 5 and thereby forms a bundle of rays that travels through within a predetermined solid angle. That is, the reflecting mirror 6 reflects light from the light-emitting section 5 and thereby forms a bundle of rays that travels toward an area in front of the headlamp 1 and emits it through the opening. The reflecting mirror 6 is for example a curved-surface-shaped (cup-shaped) member having a thin metallic film formed on a surface thereof, and opens into the direction that reflected light travels.

Further, the reflecting mirror 6 is not limited to a hemispheric mirror and may be an ellipsoidal mirror, a parabolic mirror, or a mirror having part of a curved surface thereof. That is, the reflecting mirror 6 needs only have a reflection surface containing part of a curved surface formed by rotating a figure (an ellipse, a circle, or a parabola) on an axis of rotation.

### Structure of the Laser Diode 2

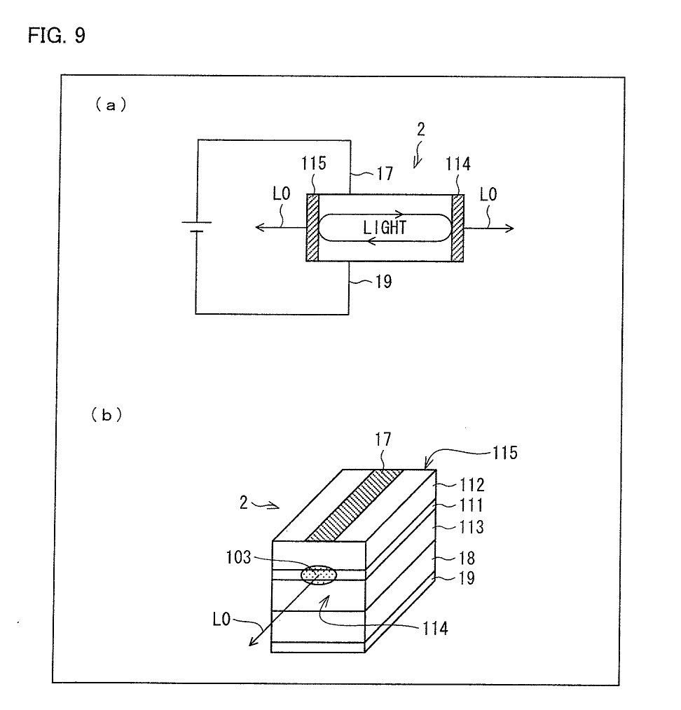

Next, a basic structure of the laser diode 2 is described. FIG. 9 shows (a) a diagram schematically showing a circuit diagram of the laser diode 2 and (b) a perspective view showing the basic structure of the laser diode 2. As shown in FIG. 9, the laser diode 2 is configured such that a cathode electrode 19, a substrate 18, a clad layer 113, an active layer 111, a clad layer 112, and an anode electrode 17 are joined on top of each other in the order named.

The substrate 18 is a semiconductor substrate. In order to obtain ultraviolet to blue excitation light to excite a fluorescent material as in the case of the present application, it is preferable to use GaN, sapphire, or SiC. In general, other examples of materials for substrates for use in laser diodes include: IV semiconductors such as Si, Ge, and SiC; III-V compound semiconductors represented by GaAs, GaP, InP, AlAs, GaN, InN, InSb, GaSb, and AlN; II-VI compound semiconductors represented by ZnTe, ZeSe, ZnS, and ZnO; oxide insulators such as ZnO, Al₂O₃, SiO₂, TiO₂, CrO₂, and CeO₂; nitride insulators such as SiN.

The anode electrode 17 is used to inject an electric current into the active layer 111 via the clad layer 112.

The cathode electrode 19, located directly under the substrate 18, is used to inject an electric current into the active layer 111 via the clad layer 113. It should be noted that the current injection is carried out by applying a forward bias to the anode and cathode electrodes 17 and 19.

The active layer 111 is sandwiched between the clad layer 113 and the clad layer 112.

Further, in order to give ultraviolet to blue excitation light, the active layer 111 and the clad layers are made of mixed semiconductors composed of AlInGaN. In general, active layers and clad layers of laser diodes are made of mixed semiconductors composed mainly of Al, Ga, In, As, P, N, and Sb, the active layer 111 and the clad layers may be made of such materials. Alternatively, the active layer 111 and the clad layers may be made of II-V compound semiconductors such as Zn, Mg, S, Se, Te, and ZnO.

Further, the active layer 111 serves as a region where the injected electric current causes light to be emitted, and the emitted light is confined in the active layer 111 due to the difference in refractive index between the clad layer 112 and the clad layer 113.

Furthermore, the active layer 111 has front and rear cleaved surfaces 114 and 115 formed to face each other to confine light that is amplified by stimulated emission, and the front and rear cleaved surfaces 114 and 115 serve as mirrors.

However, unlike in the case of mirrors that completely reflect light, part of the light that is amplified by stimulated emission exit through the front and rear cleaved surfaces 114 and 115 of the active layer 111 and becomes excitation light L0. It should be noted that the active layer 111 may form a multilayered quantum well structure.

It should be noted that the rear cleaved surface 115, which faces the front cleaved surface 114, has a reflecting film (not illustrated) formed thereon for laser emission. By thus making a difference in reflectance between the front cleaved surface 114 and the rear cleaved surface 115, the excitation light L0 is allowed to exit mostly through the front cleaved surface 114, which is a low-reflectance end face, at a luminous point 103, for example.

The clad layers 113 and 112 may be made of III-V compound semiconductors represented by n-type and p-type GaAs, GaP, InP, AlAs, GaN, InN, InSb, GaSb, and AlN, as well as II-VI compound semiconductors such as ZnTe, ZeSe, ZnS, and ZnO, and are configured such that an electric current can be injected into the active layer 111 by applying a forward bias to the anode electrode 17 and the cathode electrode 19.

The semiconductor layers such as the clad layers 113 and 112 and the active layer 111 can be formed by using common techniques of film formation such as MOCVD (metalorganic chemical vapor deposition), MBE (molecular beam epitaxy), CVD (chemical vapor deposition), laser ablation, and sputtering. The metal layers can be formed by using common techniques of film formation such as vacuum deposition, plating, laser ablation, and sputtering.

### Principle of Emission of Light by the Light-Emitting Section 5

Next, the principle of emission of light by a fluorescent material irradiated with laser light emitted by the laser diode 2 is explained.

First, when a fluorescent material included in the light-emitting section 5 is irradiated with laser light emitted by the laser diode 2, electrons existing in the fluorescent material are excited from a low-energy state to a high-energy state (excited state).

After that, since the excited state is unstable, the energy state of the electrons in the fluorescent material shifts to the original low-energy state (to a ground level of energy state or to a metastable level of energy state between an excited level and the ground level) after a certain period of time.

When electrons excited to the high-energy state shift to the low-energy state, the fluorescent material emits light.

White light can be made by either mixing three colors that satisfy the isochromatic principle or mixing two colors that satisfy a complementary chromatic relationship. On the basis of this principle or relationship, white light can be produced by so combining the color of light emitted by a laser diode and the color of light emitted by a fluorescent material.

### Another Example of a Headlamp

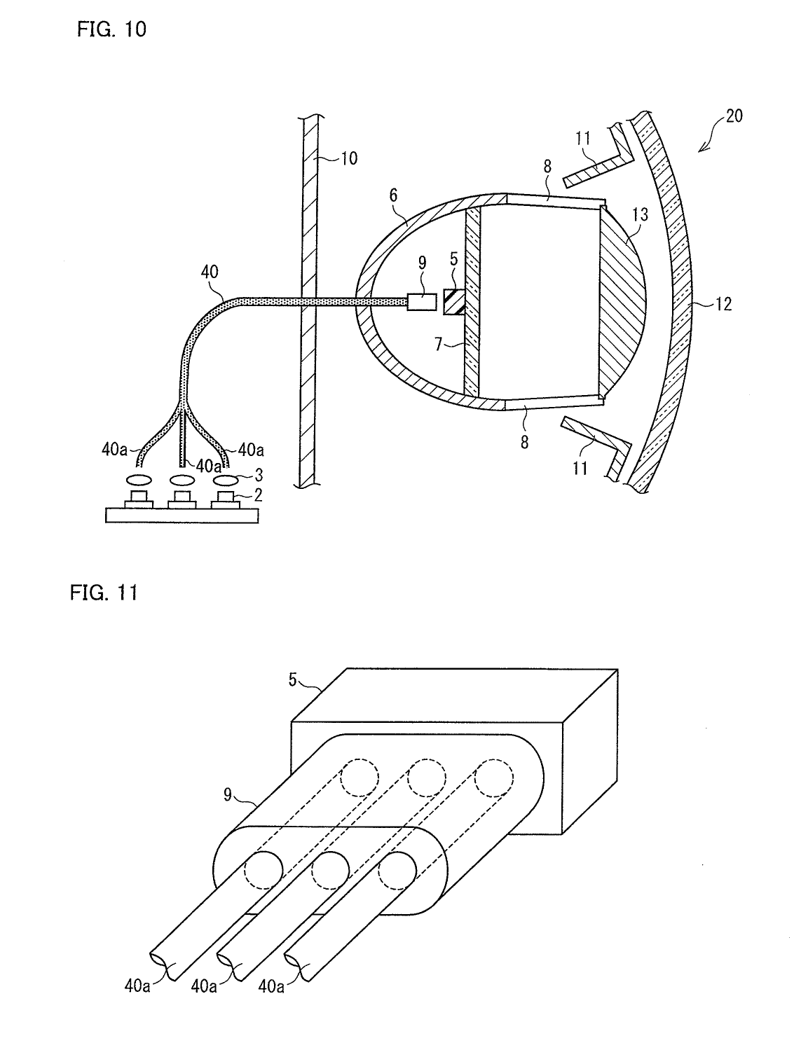

Another example of the present embodiment is described below with reference to FIG. 10. Members identical to those of the headlamp 1 are given the same reference numerals and, as such, are not described here. A projector headlamp 20 is described here.

### Configuration of a Headlamp 20

First, a configuration of a headlamp 20 according to the present embodiment is described with reference to FIG. 10. FIG. 10 is a cross-sectional view showing a configuration of a headlamp 20 that is a projector headlamp. This headlamp 20 differs from the headlamp 1 in that the head lamp 20 is a projector headlamp and includes an optical fiber 40 instead of the light guiding section 4.

As shown in FIG. 10, the headlamp 20 includes laser diodes 2, aspheric lenses 3, an optical fiber (light guiding section) 40, a ferrule 9, a light-emitting section 5, a reflecting mirror 6, a housing 10, an extension 11, a lens 12, a convex lens 13, and a lens holder 8. The laser diodes 2, the optical fiber 40, and the ferrule 9 constitute a basic structure of a light-emitting device.

Since the headlamp 20 is a projector headlamp, the headlamp 20 includes the convex lens 13. The present invention may be applied to another type of headlamp (e.g., a semisealed beam headlamp), in which case the convex lens 13 can be omitted.

### Aspheric Lenses 3

Each of the aspheric lenses 3 is a lens for causing laser light emitted by the corresponding laser diode 2 to strike an entrance end at one end of the light optical fiber 40. The number of aspheric lenses 3 that are provided is equal to the number of optical fibers 40a.

### Optical Fiber 40

The optical fiber 40, which takes the form of a bundle of optical fibers 40a, is a light guiding member that guides laser light emitted by the laser diode 2 toward the light-emitting section 5. The optical fiber 40 has a two-layer structure in which a center core is covered with a clad that is lower in refractive index than the core. The core is composed mainly of quartz glass (silicon oxide) that exhibits almost no absorption loss of laser light, and the clad is composed mainly of quartz glass or synthetic resin material that is lower in refractive index than the core.

For example, the optical fiber 40, made of quartz, has a core diameter of 200 μm, a clad diameter of 240 μm, and a numerical aperture NA of 0.22. The structure, thickness, and material of the optical fiber 40 are not limited to those mentioned above, and a cross-section of the optical fiber 40 that is perpendicular to a long side of the optical fiber 40 may be rectangular.

The optical fiber 40 has a plurality of entrance ends that receive the laser light and a plurality of exit ends through which the laser light received by the entrance ends exits. As will be mentioned later, the plurality of exit ends are positioned by the ferrule 9 with respect to a laser light irradiation surface (acceptance surface) of the light-emitting section 5.

### Ferrule 9

FIG. 11 is a diagram showing a positional relationship between the exit ends of the optical fibers 40a and the light-emitting section 5. As shown in FIG. 11, the ferrule 9 holds the exit ends of the optical fibers 40a with respect to the laser light irradiation surface of the light-emitting section 5 in a predetermined pattern. The ferrule 9 may be provided with a predetermined pattern of holes into which the optical fibers 40a are inserted. Alternatively, the ferrule 9 may be separable into an upper part and a lower part so that the optical fibers 40a are wedged between grooves formed in joint surfaces of the upper and lower parts, respectively.

The ferrule 9 is not particularly limited in material, and is made, for example, of stainless steel. Although FIG. 11 illustrates three optical fibers 40a, the number of optical fibers 40a is not limited to three. Further, the ferrule 9 needs only be fixed by a rod-like member or the like extending from the reflecting mirror 6.

By the ferrule 9 positioning the exit ends of the optical fibers 40a, different parts of the light-emitting section 5 are irradiated with those portions (greatest light intensity portions) of beams of laser light emitted by the plurality of optical fibers 40a which are greatest in light intensity in the respective light intensity distributions of the beams of laser light. This configuration focuses the beams of laser light onto one point, thereby preventing the light-emitting section 5 from markedly deteriorating. It should be noted that the exit ends may be in contact with the laser light irradiation surface or may be disposed at a slight distance from the laser light irradiation surface.

It should be noted that it is not always necessary to dispose the exit ends of the optical fibers 40a separately, and it is possible to use the ferrule 9 to position the bundle of optical fibers 40a as a single entity.

### Light-Emitting Section 5

As described above, the light-emitting section 5 produces white fluorescence upon receiving laser light having exited from the optical fiber 40 through the exit ends. Thus, the light-emitting section 5 can emit high color temperature white light. Further, the light-emitting section 5 is placed near a first focal point of the reflecting mirror 6 to be described later. The light-emitting section 5 may be fixed at a end of a tubular part extending through a central of the reflecting mirror 6. In such a case, the optical fiber 40 can be passed through the tubular part.

### Reflecting Mirror 6

The reflecting mirror 6 is for example a member having a thin metallic film formed on a surface thereof, and reflects light emitted by the light-emitting section 5, thereby converging the light onto a focal point thereof. Since the headlamp 20 is a projector headlamp, the reflecting mirror 6 has such a basic shape that a cross-section of the reflecting mirror 6 that is perpendicular to an optical axis of the reflected light is elliptical. The reflecting mirror 6 has a first focal point and a second focal point, and the second focal point is located closer to the opening of the reflecting mirror 6 that the first focal point. The convex lens 13 to be described later is placed so that its focal point is located close to the second focal point, and projects forward the light converged onto the second focal point by the reflecting mirror 6.

### Convex Lens 13

The convex lens 13 focuses light emitted by the light-emitting section 5 and projects the focused light toward an area in front of the headlamp 20. The convex lens 13 has its focal point located near the second focal point of the reflecting mirror 6 and its optical axis passing through substantially the center of a light-emitting surface of the light-emitting section 5. The convex lens 13, held by the lens holder 8, has its relative position defined with respect to the reflecting mirror 6. It should be noted that the lens holder 8 may be formed as part of the reflecting mirror 6.

### Other Members

The housing 10 forms a main body of the headlamp 20 and houses the reflecting mirror 6 and the like. The optical fiber 40 passes through the housing 10, and the laser diodes 2 are placed outside of the housing 10. Since the laser diodes 2 generate heat when they emit laser light, the laser diodes 2 can be efficiently cooled by placing the laser diodes 2 outside of the housing 10. Further, since the laser diodes 2 have a possibility of failure, it is preferable to place the laser diodes 2 in a position where it is easy to replace them. Otherwise, it is OK to place the laser diodes 2 inside of the housing 10.

The extension 11, provided on a side in front of the reflecting mirror 6, improves the appearance of the headlamp 20 by hiding the internal structure and enhances the integrity of the reflecting mirror 6 and the body of a vehicle. As with the reflecting mirror 6, the extension 11 is a member having a metallic thin film formed on a surface thereof.

The lens 12, provided in an opening in the housing 10, seals the headlamp 20 closely. Light emitted by the light-emitting section 5 is emitted toward an area in front of the headlamp 20 through the lens 12.

As described above, the structure of a headlamp per se may be of any form. What is important in the present invention is that a light-emitting section 5 includes at least either a fluorescent material sintered body obtained by sintering an oxynitride fluorescent material or a fluorescent material sintered body obtained by sintering an oxynitride fluorescent material and a nitride fluorescent material, so that even if the light-emitting section 5 is irradiated with high-power and high-density laser light, heat generated in the light-emitting section 5 can be quickly radiated outward.

### Effects That Are Brought about by a Headlamp 1

The following explains the effects that are brought about by a headlamp 1.

A headlamp 1 includes: a laser diode 2, which emits laser light; and a light-emitting section 5, which includes at least either a fluorescent material sintered body obtained by sintering an oxynitride fluorescent material or a fluorescent material sintered body obtained by sintering an oxynitride fluorescent material and a nitride fluorescent material and which produces fluorescence upon receiving laser light emitted by the laser diode 2.

According to the foregoing configuration, the light-emitting section 5 produces fluorescence upon receiving laser light emitted by the laser light source. Since such laser light is higher in power and density than light produced by using another type of excitation light source (e.g., an LED), the light-emitting section 5 tends to rise in temperature when irradiated with such laser light. Therefore, unless heat generated in the light-emitting section 5 is quickly radiated outward, the heat causes deterioration (discoloration, deformation) in the light-emitting section.

In this respect, the light-emitting section 5 of the headlamp 1 includes at least either a fluorescent material sintered body obtained by sintering an oxynitride fluorescent material or a fluorescent material sintered body obtained by sintering an oxynitride fluorescent material and a nitride fluorescent material, and a base material for the oxynitride fluorescent material is silicon nitride (SiN: thermal conductivity (approximately 20 W/mK), which is higher in thermal conductivity than many other fluorescent materials. That is, by including a light-emitting section 5 that includes an oxynitride fluorescent material having high thermal conductivity, the headlamp 1 allows heat generated in the light-emitting section 5 to be quickly radiated outward, for example, by bringing a thermally conductive member into contact with the light-emitting section 5. Therefore, the headlamp 1 can easily solve the problem of deterioration in the light-emitting section 5 due to heat even if the light-emitting section 5 is irradiated with high-power and high-density laser light.

In addition, the oxynitride fluorescent material increases in transparency when sintered to form a fluorescent material sintered body, thereby coming to exhibit high translucency. That is, by including a fluorescent material sintered body obtained by sintering an oxynitride fluorescent material, the light-emitting section 5 comes to serve as a fluorescent material and a radiator itself and, at the same time, have high translucency. Therefore, for example, when irradiated with blue laser light, the light-emitting section 5 can convert part of the blue light into yellow light while transmitting the blue light and transmit part of the blue light because of its translucency. This allows the light-emitting section 5 to output white light made by mixing the blue light and the yellow light together. Moreover, in so doing, the light-emitting 5 functions as a radiator itself, and as such, can also suppress heat deterioration.

Thus, by including the foregoing configuration, the headlamp 1 brings about an effect of preventing the light-emitting section 5 from rising in temperature when irradiated with laser light.

A vehicle headlamp according to the present invention includes: a headlamp 1; and a reflecting mirror 6, which, by reflecting light emitted by the light-emitting section, forms a bundle of rays that travels through within a predetermined solid angle.

According to the foregoing configuration, by reflecting light emitted by the light-emitting section, the reflecting mirror 6 can form a bundle of rays that travels toward an area in front of the vehicle headlamp. Moreover, since the vehicle headlamp includes the headlamp 1, the vehicle headlamp can prevent the light-emitting section 5 from rising in temperature when irradiated with laser light. Therefore, in the vehicle headlamp, deterioration (discoloration, deformation) in the light-emitting section 5 due to heat is suppressed, so that the life of the vehicle headlamp can be extended.

Further, the headlamp 1 is preferably configured such that the fluorescent material sintered body includes plural types of sintered body 50a, etc. that produce different colors of fluorescence from each other.

According to the foregoing configuration, the fluorescent material sintered body includes plural types of sintered body 50a, etc. that produce different colors of fluorescence from each other. This allows the headlamp 1 to, by being irradiated with laser light, easily realize outputting of a wide variety of colors made by mixing a plurality of different colors of fluorescence together, controlling of color temperatures, etc.

Further, the headlamp 1 is preferably configured such that sintered bodies 50a, etc. are joined on top of each other along an optical axis of the laser light.

It is extremely technically difficult to mix different types of fluorescent material and sinter them into a transparent sintered body.

In view of this, by joining the sintered bodies 50a, etc. on top of each other along an optical axis of the laser light, the light-emitting section 50, etc. can be fabricated in such a way as to include sintered bodies 50a, etc. that produce different colors of fluorescence from each other, whereby the aforementioned technical difficulty can be overcome. Further, by changing the properties (material, thickness, etc.) of each of the sintered bodies 50a, etc. joined on top of each other, outputting of a wide variety of colors, controlling of color temperatures, etc. can be realized to give a rich variety.

Further, the headlamp 1 is preferably configured such that the sintered bodies 50a, etc. are arranged adjacent to each other.

It is extremely technically difficult to mix different types of fluorescent material and sinter them into a transparent sintered body.

In view of this, by arranging the sintered bodies 50a, etc. adjacent to each other, the light-emitting section 51, etc. can be fabricated in such a way as to include sintered bodies 50a, etc. that produce different colors of fluorescence from each other, whereby the aforementioned technical difficulty can be overcome. Further, by changing the arrangement of the sintered bodies 50a, etc., outputting of a wide variety of colors, controlling of color temperatures, etc. can be realized to give a rich variety.

Further, the headlamp 1 is preferably configured such that the plural types of sintered body produce blue, red, and green fluorescence, respectively.

In some applications of the lighting device, e.g., in the application of the lighting device in a vehicle headlamp, the required range of chromaticity of white is regulated by law in Japan. In view of this, on the assumption that the headlamp 1 is applied to a vehicle headlamp, it is preferable that the light-emitting section 50, etc. be realized in the form of a configuration capable of outputting white light.

In view of this, by producing blue, red, and green fluorescence, respectively, the plural types of sintered body can output white made by mixing blue, red, and green together. Further, as for color temperatures, by appropriately changing the component ratio among the three types of sintered body, a color temperature can be set which is liked by many users in the marketplace.

Further, the headlamp 1 is preferably configured such that the oxynitride fluorescent material is a Ce-doped Caα-SiAlON fluorescent material, a Ce-doped β-SiAlON fluorescent material, or a Ce-doped JEM-phase fluorescent material.

The foregoing configuration can convert part of laser light into blue light while the laser light is traveling through the light-emitting section 50, etc., and can give high luminous efficiency.

Further, the headlamp 1 is preferably configured such that the nitride fluorescent material is a Eu-doped CASN fluorescent material doped or a Eu-doped SCASN fluorescent material.

The foregoing configuration can convert part of laser light into red light while the laser light is traveling through the light-emitting section 50, etc., and can give high luminous efficiency.

Further, the headlamp 1 is preferably configured such that the oxynitride fluorescent material is a Eu-doped β-SiAlON fluorescent material.

The foregoing configuration can convert part of laser light into green light while the laser light is traveling through the light-emitting section 50, etc., and can give high luminous efficiency.

Further, the headlamp 1 is preferably configured such that the light-emitting section 53, etc. includes a translucent medium that transmits the laser light.

According to the foregoing configuration, the light-emitting section 51, etc. includes at least either a fluorescent material sintered body obtained by sintering an oxynitride fluorescent material or a fluorescent material sintered body obtained by sintering an oxynitride fluorescent material and a nitride fluorescent material and a translucent medium 54b that transmits the laser light. For example, in a case where the fluorescent material sintered body outputs yellow light when irradiated with blue laser light, the fluorescent material sintered body can output white light made by mixing together the yellow light and blue light having traveled through the translucent medium 54b.

Thus, by including the foregoing configuration, the headlamp 1 allows laser light traveling through the translucent medium 54b to be outputted from the light-emitting section 51, etc. with no change in color of the laser light. This eliminates the need for the light-emitting section 51, etc. to include an oxynitride fluorescent material for converting into the color of the laser light.

Since a coherent component contained in laser light is highly likely to cause damage to human eyes, there may a case where it is considered problematic to directly output the laser light from the headlamp 1 outward. In such a case, it is possible to use, for example, a transmitting filter to output only incoherent light toward the outside of the headlamp 1.

In order to solve the foregoing problems, a vehicle headlamp according to the present invention may include: a lighting device as described above; and a reflecting mirror which, by reflecting light emitted by the light-emitting section, forms a bundle of rays that travels through within a predetermined solid angle.

According to the foregoing configuration, by reflecting light emitted by the light-emitting section, the reflecting mirror can form a bundle of rays that travels toward an area in front of the vehicle headlamp. Moreover, since the vehicle headlamp includes the lighting device, the vehicle headlamp can prevent the light-emitting section from rising in temperature when irradiated with laser light. Therefore, in the vehicle headlamp according to the present invention, deterioration (discoloration, deformation) in the light-emitting section due to heat is suppressed, so that the life of the vehicle headlamp can be extended.

Further, the lighting device of the present invention is preferably configured such that the fluorescent material sintered body includes plural types of sintered body that produce different colors of fluorescence from each other.

According to the foregoing configuration, the fluorescent material sintered body includes plural types of sintered body that produce different colors of fluorescence from each other. This allows the lighting device of the present invention to prevent the light-emitting section from rising in temperature when irradiated with laser light and to, by being irradiated with laser light, easily realize outputting of a wide variety of colors made by mixing a plurality of different colors of fluorescence together, controlling of color temperatures, etc.

Further, the lighting device of the present invention is preferably configured such that the plural types of sintered body are joined on top of each other along an optical axis of the laser light.

It is extremely technically difficult to mix different types of fluorescent material and sinter them into a transparent sintered body.

In view of this, by joining the plural types of sintered body on top of each other along an optical axis of the laser light, the light-emitting section can be fabricated in such a way as to include plural types of sintered body that produce different colors of fluorescence from each other, whereby the aforementioned technical difficulty can be overcome. Further, by changing the properties (material, thickness, etc.) of each of the plural types of sintered body joined on top of each other, outputting of a wide variety of colors, controlling of color temperatures, etc. can be realized to give a rich variety.

Further, the lighting device of the present invention is preferably configured such that the plural types of sintered body are arranged adjacent to each other.

It is extremely technically difficult to mix different types of fluorescent material and sinter them into a transparent sintered body.

In view of this, by arranging the plural types of sintered body adjacent to each other, the light-emitting section can be fabricated in such a way as to include plural types of sintered body that produce different colors of fluorescence from each other, whereby the aforementioned technical difficulty can be overcome. Further, by changing the arrangement of the plural types of sintered body, outputting of a wide variety of colors, controlling of color temperatures, etc. can be realized to give a rich variety.

Further, the lighting device of the present invention is preferably configured such that the plural types of sintered body produce blue, red, and green fluorescence, respectively.

In some applications of the lighting device, e.g., in the application of the lighting device in a vehicle headlamp, the required range of chromaticity of white is regulated by law. In view of this, on the assumption that the lighting device according to the present invention is applied to a vehicle headlamp, it is preferable that the light-emitting section be realized in the form of a configuration capable of outputting white light.

In view of this, by producing blue, red, and green fluorescence, respectively, the plural types of sintered body can output white made by mixing blue, red, and green together. Further, as for color temperatures, by appropriately changing the component ratio among the three types of sintered body, a color temperature can be set which is liked by many users in the marketplace.

Further, the lighting device of the present invention is preferably configured such that the oxynitride fluorescent material is a Ce-doped Caα-SiAlON fluorescent material, a Ce-doped β-SiAlON fluorescent material, or a Ce-doped JEM-phase fluorescent material.

The foregoing configuration can convert part of laser light into blue light while the laser light is traveling through the light-emitting section, and can give high luminous efficiency.

Further, the lighting device of the present invention is preferably configured such that the oxynitride fluorescent material is a Eu-doped CASN fluorescent material doped or a Eu-doped SCASN fluorescent material.

The foregoing configuration can convert part of laser light into red light while the laser light is traveling through the light-emitting section, and can give high luminous efficiency.

Further, the lighting device of the present invention is preferably configured such that the oxynitride fluorescent material is a Eu-doped β-SiAlON fluorescent material.

The foregoing configuration can convert part of laser light into green light while the laser light is traveling through the light-emitting section, and can give high luminous efficiency.

Further, the lighting device of the present invention is preferably configured such that the light-emitting section includes a translucent medium that transmits the laser light.

According to the foregoing configuration, the light-emitting section includes a fluorescent material sintered body obtained by sintering an oxynitride fluorescent material and a translucent medium that transmits the laser light. For example, in a case where the fluorescent material sintered body outputs yellow light when irradiated with blue laser light, the fluorescent material sintered body can output white light made by mixing together the yellow light and blue light having traveled through the translucent medium.

Thus, by including the foregoing configuration, the lighting device of the present invention allows laser light traveling through the translucent medium to be outputted from the light-emitting section with no change in color of the laser light. This eliminates the need for the light-emitting section to include an oxynitride fluorescent material for converting into the color of the laser light.

Since a coherent component contained in laser light is highly likely to cause damage to human eyes, there may a case where it is considered problematic to directly output the laser light from the lighting device outward. In such a case, it is possible to use, for example, a transmitting filter to block the coherent component and transmit the incoherent component.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be applied to lighting devices and headlamps that are required to produce illuminating light at high color temperatures and, in particular, to headlamps for vehicles, etc.

### REFERENCE SIGNS LIST

1, 20 Headlamp (lighting device)
2 Laser diode
3 Aspheric lens
4 Light guiding section
4a Light entrance surface
4b Light exit surface
5, 50 to 54 Light-emitting section
6 Reflecting mirror
8 Lens holder
9 Ferrule
10 Housing
11 Extension
12 Lens
13 Convex lens
17 Anode electrode
18 Substrate
19 Cathode electrode
40, 40a Optical fiber
50a to 52a, 50b to 52b, 50c to 52c, 54a to 54c Fluorescent material sintered body (sintered body)
60 Cutter
103 Luminous point
111 Active layer
112, 113 Clad layer
114, 115 Open face

1. A lighting device comprising:
a laser light source, which emits laser light; and
a light-emitting section, which includes at least either a fluorescent material sintered body obtained by sintering an oxynitride fluorescent material or a fluorescent material sintered body obtained by sintering an oxynitride fluorescent material and a nitride fluorescent material and which produces fluorescence upon receiving laser light emitted by the laser light source.

2. The lighting device as set forth in claim 1, wherein the fluorescent material sintered body includes plural types of sintered body that produce different colors of fluorescence from each other.

3. The lighting device as set forth in claim 2, wherein the plural types of sintered body are joined on top of each other along an optical axis of the laser light.

4. The lighting device as set forth in claim 2, wherein the plural types of sintered body are arranged adjacent to each other.

5. The lighting device as set forth in claim 2, wherein the plural types of sintered body produce blue, red, and green fluorescence, respectively.

6. The lighting device as set forth in claim 1, wherein the oxynitride fluorescent material is a Ce-doped Caα-SiAlON fluorescent material, a Ce-doped β-SiAlON fluorescent material, or a Ce-doped JEM-phase fluorescent material.

7. The lighting device as set forth in claim 2, wherein the nitride fluorescent material is a Eu-doped CASN fluorescent material or a Eu-doped SCASN fluorescent material.

8. The lighting device as set forth in claim 2, wherein the oxynitride fluorescent material is a Eu-doped β-SiAlON fluorescent material.

9. The lighting device as set forth in claim 1, wherein the light-emitting section includes a translucent medium that transmits the laser light.

10. A lighting device comprising:
a laser light source, which emits laser light; and
a light-emitting section, which includes an oxynitride fluorescent material and a sealant composed of silicon nitride and which produces fluorescence upon receiving laser light emitted by the laser light source.

11. A vehicle headlamp comprising:
a lighting device as set forth in claim 1; and
a reflecting mirror, which, by reflecting light emitted by the light-emitting section, forms a bundle of rays that travels through within a predetermined solid angle.
